(19) United States
(12) Patent Application Publication
(10) Pub. No.: US 2024/0176346 A1
(43) Pub. Date: May 30, 2024

(54) FLIGHT CONTROL INFORMATION SETTING DEVICE, UNMANNED AERIAL VEHICLE MONITORING SYSTEM, AND FLIGHT CONTROL INFORMATION SETTING METHOD

(71) Applicant: Rakuten Group, Inc., Tokyo (JP)

(72) Inventors: Asaki MATSUMOTO, Tokyo (JP); Takayoshi Inuma, Tokyo (JP); Shingo Kajiwara, Tokyo (JP)

(73) Assignee: Rakuten Group, Inc., Tokyo (JP)

(21) Appl. No.: 18/508,817

(22) Filed: Nov. 14, 2023

(30) Foreign Application Priority Data
Nov. 29, 2022 (JP) 2022-190525

(51) Int. Cl. G05D 1/02; G06Q 10/1093

(52) U.S. Cl. CPC G05D 1/0202; G06Q 10/1097; B64U 2101/00

(57) ABSTRACT

The monitoring task management server MS acquires the monitoring schedule including the time zone in which the operator OPn can perform the monitoring task, acquires the monitoring required timing that changes according to a change in at least one of the flight speed and the flight path of the UAVm, and sets at least one of the flight speed and the flight path of the UAVm such that the monitoring required timing of the UAVm is included in the time zone in which the operator OPn can perform the monitoring task in the monitoring schedule of the operator OPn.

### CROSS REFERENCE TO RELATED APPLICATION

This application claims priority from Japanese Patent Application No. 2022-190525 which was filed on Nov. 29, 2022, the disclosure of which is herein incorporated by reference in its entirety.

### TECHNICAL FIELD

One or more embodiments of the present invention relates to a technical field such as a system for monitoring an unmanned aerial vehicle used for delivery of an article.

### RELATED ART

Conventionally, for example, as disclosed in JP 2022-529507 A, there is known a technique in which a plurality of operators arranged at a place away from an unmanned aerial vehicle monitor and control a plurality of flying unmanned aerial vehicles via a computing device. According to the technique disclosed in JP 2022-529507 A, it is possible to monitor and control a large number of unmanned aerial vehicles by one operator.

Meanwhile, it is undesirable for one operator to simultaneously monitor a plurality of unmanned aerial vehicles from the viewpoint of safety and the like. In the future, when articles are delivered from a plurality of bases by a plurality of unmanned aerial vehicles, in order to appropriately perform the monitoring task of the unmanned aerial vehicle by the operator, it is desirable to perform adjustment so as to cause monitoring required timings which are required to respectively monitor the plurality of unmanned aerial vehicles not to overlap with each other.

Therefore, one or more embodiments of the present invention are to providing a flight control information setting device, an unmanned aerial vehicle monitoring system, and a flight control information setting method capable of appropriately adjusting a monitoring required timing for causing an operator to perform a monitoring task.

### SUMMARY

(An aspect 1) In response to the above issue, a flight control information setting device includes: at least one memory configured to store program code; and at least one processor configured to access the program code and operate as instructed by the program code. The program code includes: first acquisition code configured to cause the at least one processor to acquire a monitoring schedule of an operator who performs a monitoring task for monitoring an unmanned aerial vehicle used for delivering an article, the monitoring schedule including a time zone in which the operator can perform the monitoring task; second acquisition code configured to cause the at least one processor to acquire a monitoring required timing at which the unmanned aerial vehicle needs to be monitored, the monitoring required timing changing according to a change in at least one of a flight speed of the unmanned aerial vehicle and a flight path thereof; and setting code configured to cause the at least one processor to set at least one of the flight speed of the unmanned aerial vehicle and the flight path thereof so as to cause the monitoring required timing to be included in the time zone in which the operator can perform the monitoring task in the monitoring schedule of the operator.

(An aspect 2) The setting code may be further configured to cause the at least one processor to, in a case where the monitoring required timing is advanced to be included in the time zone in which the monitoring task is performable, change the flight speed of the unmanned aerial vehicle so as to increase the flight speed or change the flight path of the unmanned aerial vehicle so as to shorten the flight path.

(An aspect 3) The setting code may be further configured to cause the at least one processor to, in a case where the monitoring required timing is advanced to be included in the time zone in which the monitoring task is performable, change the flight speed of the unmanned aerial vehicle so as to increase the flight speed and change the flight path of the unmanned aerial vehicle so as to shorten the flight path.

(An aspect 4) The setting code may be further configured to cause the at least one processor to, in a case where the monitoring required timing is delayed to be included in the time zone in which the monitoring task is performable, change the flight speed of the unmanned aerial vehicle so as to reduce the flight speed or change the flight path of the unmanned aerial vehicle so as to lengthen the flight path.

(An aspect 5) The setting code may be further configured to cause the at least one processor to, in a case where the monitoring required timing is delayed to be included in the time zone in which the monitoring task is performable, change the flight speed of the unmanned aerial vehicle so as to reduce the flight speed and change the flight path of the unmanned aerial vehicle so as to lengthen the flight path.

(An aspect 6) The second acquisition code may be further configured to cause the at least one processor to acquire a plurality of the monitoring required timings. The setting code may be further configured to cause the at least one processor to set at least one of the flight speed of the unmanned aerial vehicle and the flight path thereof so as to cause the plurality of monitoring required timings to be included in the time zone in which the monitoring task is performable in the monitoring schedule of the operator.

(An aspect 7) The setting code may be further configured to cause the at least one processor to set at least one of the flight speed of the unmanned aerial vehicle and the flight path thereof so as to enable the unmanned aerial vehicle to deliver the article in a deliverable time selected by a delivery requester and to cause the monitoring required timing to be included in the time zone in which the monitoring task is performable.

(An aspect 8) The setting code may be further configured to cause the at least one processor to perform, in a case where it is difficult to cause the monitoring required timing of the unmanned aerial vehicle to be included in the time zone in which the monitoring task is performable by changing the flight speed of the unmanned aerial vehicle, setting so as to cause the monitoring required timing to be included in the time zone in which the monitoring task is performable by changing the flight path of the unmanned aerial vehicle.

(An aspect 9) The unmanned aerial vehicle may be a first unmanned aerial vehicle. The monitoring schedule may include a time zone having a monitoring task already allocated thereto and configured to monitor a second unmanned aerial vehicle different from the first unmanned aerial vehicle. The program code may further include change code configured to cause the at least one processor to, in a case where it is difficult to cause the monitoring required timing of the first unmanned aerial vehicle to be included in the time zone in which the operator can perform the monitoring task even if at least one of the flight speed of the first unmanned aerial vehicle and the flight path thereof is changed, change the monitoring required timing of the second unmanned aerial vehicle by changing at least one of the flight speed of the second unmanned aerial vehicle and the flight path thereof, and change, according to a change in the monitoring required timing, the time zone having the monitoring task already allocated thereto and configured to monitor the second unmanned aerial vehicle in the monitoring schedule. The setting code may be further configured to cause the at least one processor to set at least one of the flight speed of the first unmanned aerial vehicle and the flight path thereof so as to cause the monitoring required timing of the first unmanned aerial vehicle to be included in an idle time zone generated by changing the time zone.

(An aspect 10) The program code further may include allocation code configured to cause the at least one processor to allocate, to the time zone, the monitoring task to be performed at the monitoring required timing included in the time zone in which the monitoring task is performable in the monitoring schedule of the operator by setting at least one of the flight speed and the flight path.

(An aspect 11) The unmanned aerial vehicle may include a first unmanned aerial vehicle and a second unmanned aerial vehicle. The monitoring schedule of the operator may have a monitoring task allocated thereto and configured to monitor the first unmanned aerial vehicle and a monitoring task allocated thereto and configured to monitor the second unmanned aerial vehicle. The program code may further include delay control code configured to cause the at least one processor to delay, in a case where a delay occurs in a delivery schedule of the first unmanned aerial vehicle, the monitoring required timing of the first unmanned aerial vehicle. The setting code may be further configured to cause the at least one processor to reset, in a case where at least a part of the monitoring required timing after the delay of the first unmanned aerial vehicle and at least a part of the monitoring required timing of the second unmanned aerial vehicle overlap with each other, at least one of the flight speed of the second unmanned aerial vehicle and the flight path thereof so as to cause the monitoring required timing of the second unmanned aerial vehicle to be included in the time zone in which the operator can perform the monitoring task in the monitoring schedule of the operator.

(An aspect 12) The unmanned aerial vehicle may include a first unmanned aerial vehicle and a second unmanned aerial vehicle. The monitoring schedule of a first operator among a plurality of the operators may have a monitoring task allocated thereto and configured to monitor the first unmanned aerial vehicle and a monitoring task allocated thereto and configured to monitor the second unmanned aerial vehicle. The program code may further include delay control code configured to cause the at least one processor to delay, in a case where a delay occurs in a delivery schedule of the first unmanned aerial vehicle, the monitoring required timing of the first unmanned aerial vehicle. The allocation code may be further configured to cause the at least one processor to allocate, in a case where at least a part of the monitoring required timing after the delay of the first unmanned aerial vehicle and at least a part of the monitoring required timing of the second unmanned aerial vehicle overlap with each other, the monitoring task to be performed at the monitoring required timing of the second unmanned aerial vehicle to the time zone in which the monitoring task is performable in the monitoring schedule of the first operator or the monitoring schedule of a second operator other than the first operator.

(An aspect 13) The program code may further include flight control code configured to cause the at least one processor to control flight of the unmanned aerial vehicle on the basis of at least one of the set flight speed of the unmanned aerial vehicle and the set flight path thereof.

(An aspect 14) The program code may further include presentation code configured to cause the at least one processor to present, to a delivery requester of the article, a predetermined number of deliverable time frames of the article by the unmanned aerial vehicle in a selectable manner. The second acquisition code may be further configured to cause the at least one processor to acquire the monitoring required timing on the basis of the deliverable time frame selected by the delivery requester among the presented deliverable time frames.

(An aspect 15) The monitoring schedule may have a monitoring task already allocated thereto and configured to monitor another unmanned aerial vehicle deployed in a base different from a base of the unmanned aerial vehicle.

(An aspect 16) The program code may further include transmission code configured to cause the at least one processor to transmit, to a terminal used by the operator, information for causing the operator to perform the monitoring task to be performed at the monitoring required timing in response to arrival of the monitoring required timing.

(An aspect 17) The monitoring required timing may be at least one of a plurality of timings separated by time in a delivery schedule related to one delivery by the unmanned aerial vehicle.

(An aspect 18) An unmanned aerial vehicle monitoring system includes: at least one memory configured to store program code; and at least one processor configured to access the program code and operate as instructed by the program code. The program code include: first acquisition code configured to cause the at least one processor to acquire a monitoring schedule of an operator who performs a monitoring task for monitoring an unmanned aerial vehicle used for delivering an article, the monitoring schedule including a time zone in which the operator can perform the monitoring task; second acquisition code configured to cause the at least one processor to acquire a monitoring required timing at which the unmanned aerial vehicle needs to be monitored, the monitoring required timing changing according to a change in at least one of a flight speed of the unmanned aerial vehicle and a flight path thereof; and setting code configured to cause the at least one processor to set at least one of the flight speed of the unmanned aerial vehicle and the flight path thereof so as to cause the monitoring required timing to be included in the time zone in which the operator can perform the monitoring task in the monitoring schedule of the operator.

(An aspect 19) A flight control information setting method executed by a computer includes: acquiring a monitoring schedule of an operator who performs a monitoring task for monitoring an unmanned aerial vehicle used for delivering an article, the monitoring schedule including a time zone in which the operator can perform the monitoring task; acquiring a monitoring required timing at which the unmanned aerial vehicle needs to be monitored, the monitoring required timing changing according to a change in at least one of a flight speed of the unmanned aerial vehicle and a flight path thereof; and setting at least one of the flight speed of the unmanned aerial vehicle and the flight path thereof so as to cause the monitoring required timing to be included in the time zone in which the operator can perform the monitoring task in the monitoring schedule of the operator.

### BRIEF DESCRIPTION OF THE DRAWINGS

FIG. 1 is a diagram illustrating a schematic configuration example of a delivery management system S.

FIG. 2 is a conceptual diagram illustrating a state in which a UAV1 delivers an item to a delivery destination.

FIG. 3 is a diagram illustrating a schematic configuration example of a monitoring task management server MS.

FIG. 4 is a diagram illustrating an example of a monitoring required timing calculation table.

FIG. 5 is a diagram illustrating examples of contents of a monitoring plan management database 126.

FIG. 6 is a diagram illustrating functional block examples in a control unit 13.

FIG. 7 is a diagram illustrating an example of a deliverable time frame selection screen displayed on an orderer terminal UT.

FIG. 8 is a conceptual diagram illustrating a temporal relationship between monitoring schedules SC1 and SC2 of operators O1 and O2 and monitoring required timing frames TW1 to TW4 for each task type.

FIG. 9 is a conceptual diagram illustrating an example in which a time zone to which a monitoring task for monitoring an UAV2 is already allocated is changed.

FIG. 10 is a diagram illustrating an example of a monitoring task performance screen displayed on an operator terminal OT1.

FIG. 11 is a conceptual diagram illustrating an example in which a monitoring task to be performed at the monitoring required timing of an UAV2 is replaced from a monitoring schedule of an operator O1 to a monitoring schedule of an operator O4.

FIG. 12 is a flowchart illustrating an example of monitoring plan determination processing of the control unit 13 in the monitoring task management server MS.

FIG. 13 is a flowchart illustrating an example of monitoring task information transmission processing of the control unit 13 in the monitoring task management server MS.

### DETAILED DESCRIPTION

Hereinbelow, one or more embodiments of the present invention will be described with reference to the drawings. The following embodiment is an embodiment in a case where the present invention is applied to a delivery management system that manages delivery of an article by an unmanned aerial vehicle (hereinafter, referred to as a “UAV (unmanned aerial vehicle)”) such as a drone. The UAV is an example of an unmanned flying object. Incidentally, in the following embodiment, a description will be given, as an example, as to a case in which an item (an example of an article) sold (provided) at a store is ordered from a terminal (hereinafter, referred to as an “orderer terminal”) used by an orderer (an example of a delivery requester) to an order processing server, and the item is delivered to a delivery destination.

### [1. Configuration and Operation Outline of Delivery Management System S]

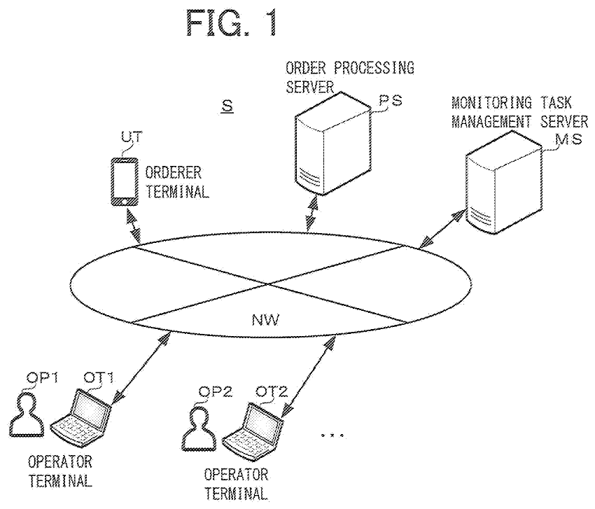

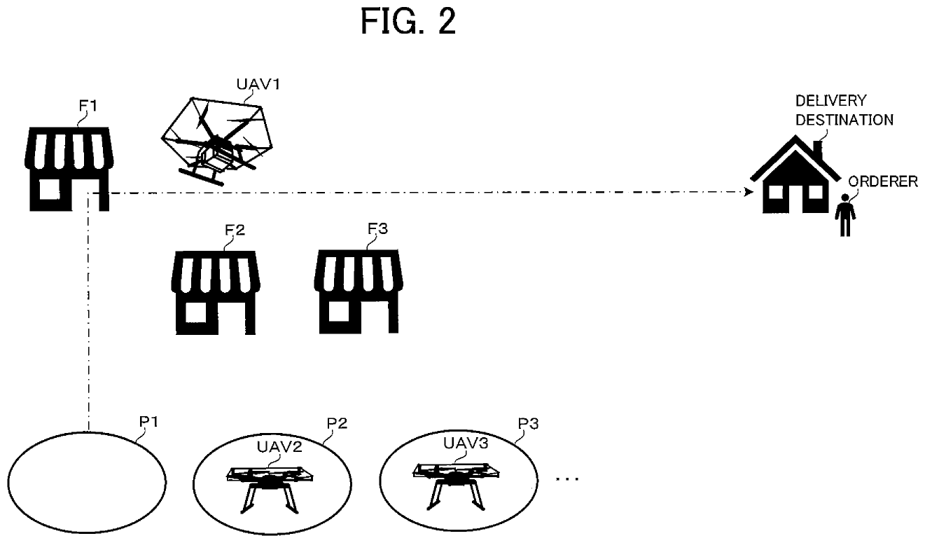

First, a description will be given as to a configuration and an operation outline of a delivery management system S according to the present embodiment with reference to FIGS. 1 and 2. FIG. 1 is a diagram illustrating a schematic configuration example of the delivery management system S. As illustrated in FIG. 1, the delivery management system S includes an order processing server PS, a monitoring task management server MS, a plurality of operator terminals OTn (n=1, 2, . . . ), and the like. Here, the monitoring task management server MS is an example of a flight control information setting device. The monitoring task management server MS and the plurality of operator terminals OTn can form an unmanned aerial vehicle monitoring system of the present invention. Moreover, the monitoring task management server MS may be formed to be integrated with the order processing server PS. The operator terminal OTn is used by an operator OPn (n=1, 2 . . . ). For example, an operator terminal OT1 is used by an operator OP1 (an example of a first operator), and an operator terminal OT2 is used by an operator OP2 (an example of a second operator). The order processing server PS, the monitoring task management server MS, and the operator terminal OTn are connected to a communication network NW. The communication network NW includes, for example, the Internet, a mobile communication network and a radio base station thereof, and the like.

FIG. 2 is a conceptual diagram illustrating a state in which a UAV1 delivers an item to a delivery destination. In the example of FIG. 2, a plurality of UAVms (m=1, 2, 3 . . . ) used for delivery of items are respectively deployed in different bases Pm (m=1, 2, 3 . . . ). Among the plurality of UAVm, an UAV1 is an example of a first UAV, and an UAV2 is an example of a second UAV. Since an item (e.g., product, merchandise, goods, or commodity) is sold at a store Fo (o=1, 2, 3 . . . ), the UAVm flies to the store Fo from the base Pm to pick up the item. For example, as illustrated in FIG. 2, after the order of an item is confirmed, the UAV1 flies from the base P1 to the store F1 that sells the item, loads the item in the store F1, and flies to a delivery destination according to set flight control information. The flight control information is information for controlling the flight of the UAV1, and includes parameters of at least one of a flight speed and a flight path of the UAV1. Incidentally, a plurality of UAVms may be deployed in one base Pm. For example, the UAV1 and the UAV2 may be deployed in the base P1. Moreover, the base Pm and the store Fo may be in the same place. For example, the store F1 may be installed in the base P1. In this case, the UAV1 may not fly from the base P1 to the store F1.

The order processing server PS is a server that receives and processes an order from an orderer terminal UT (for example, a mobile terminal such as a smartphone) that has accessed via the communication network NW, and transmits information on the received order to the monitoring task management server MS. Here, the information on the order includes, for example, an order ID (identification information on the order), a user ID of an orderer (identification information on the orderer), an item ID of an item ordered by the orderer (identification information on the item), an item name, a store ID of a store that sells the item (identification information on the store Fo), position information of a delivery destination (for example, latitude and longitude), and the like. Incidentally, information on the item (for example, an item name and a photographic image of the item) is selectably (in a selectable manner) presented to the orderer from the order processing server PS (that is, the information is displayed on the orderer terminal UT).

Moreover, the order processing server PS selectably presents, to the orderer, a deliverable time frame (for example, a plurality of different deliverable time frames) of the item (that is, the deliverable time frame is displayed on the orderer terminal UT). The deliverable time frame is provided from the monitoring task management server MS. The order of the item is confirmed when any deliverable time frame is selected by the orderer from the deliverable time frame presented to the orderer. Here, the deliverable time frame is a time zone in which the item can be reached to the delivery destination. In other words, the deliverable time frame is a scheduled time zone in which the UAVm loaded with the item arrives at the delivery destination. Alternatively, the deliverable time frame may be a scheduled time zone in which the UAVm arriving at the delivery destination lands on the ground or the like and a recipient can receive the item from the UAVm. Incidentally, the deliverable time may be a time (for example, 12:00), but is desirably a time zone (for example, from 12:00 to 12:15) in consideration of a certain margin.

The monitoring task management server MS is a server that manages information on a monitoring task for monitoring the UAVm used for delivery of the item. The monitoring task can be referred to as, for example, operation (work) of monitoring the state of the UAVm and the peripheral situation of the UAVm. The monitoring task is performed by the operator OPn via the operator terminal OTn at a monitoring required timing at which the UAVm is required to be monitored (the monitoring required timing of the UAVm). The monitoring task may include a terminal operation (that is, the operation of the operator terminal OTn) for performing flight control (for example, movement control and hovering control) of the UAVm depending on the situation. Moreover, the monitoring task is allocated to a time zone in which the monitoring task can be performed in the monitoring schedule of the operator OPn.

In the present embodiment, for example, a scene is assumed in which the operator OP1 in a monitoring base performs a monitoring task for each of the plurality of UAVms that respectively perform delivery at different bases Pm. In order to perform safe delivery, information on the UAVm is displayed on the operator terminal OT1 used by the operator OP1 at a timing when a monitoring task by the operator OP1 is necessary, such as when each UAVm arrives above the store Fo or when each UAVm lands. For example, even if the UAV1 that has left the base P1 arrives above the store F1, in a case where the delivery preparation of the UAV2 is completed in the store F2 at the same timing and the operator OP1 is performing the monitoring task, the monitoring task for the UAV1 cannot be performed.

Incidentally, the monitoring in this embodiment includes the gaze of the operator OPn through vision (looks carefully). Therefore, the monitoring required timing can also be referred to as gaze (gaze required) timing. Moreover, the monitoring required timing is desirably a plurality of timings (an example of a first monitoring required timing and a second monitoring required timing) separated by time in the delivery schedule related to one delivery by the UAVm to be monitored. As a result, in the delivery schedule related to one delivery, it is possible to cause the operator OPn to efficiently perform the monitoring task to be performed at the monitoring required timing of the UAVm. However, the monitoring required timing may be one timing in the delivery schedule related to one delivery by the UAVm to be monitored. Here, the timing may be a time point (in other words, time) or a time zone (that is, a certain time width may be provided). A delivery schedule is, for example, a schedule until the UAVm takes off from the base Pm and lands at the delivery destination via the store Fo (alternatively, until the UAVm takes off from the delivery destination).

Moreover, the monitoring task management server MS regularly or irregularly receives UAV information on the UAVm from the UAVm via the communication network NW. Here, the UAV information includes, for example, a position, a state, a battery remaining amount, and the like detected by various sensors of the UAVm. Moreover, the UAV information may include a UAV video captured by a UAVm camera. The UAV video may include, for example, an obstacle that may obstruct take-off and landing of the UAVm. Moreover, the monitoring task management server MS may regularly or irregularly receive UAV peripheral information on the peripheral situation of the UAVm from various sensors installed in the store Fo or the base Pm via the communication network NW. Moreover, the UAV peripheral information includes a wind direction, a wind speed, and a rainfall amount detected by a weather sensor installed in the store Fo or the base Pm. The UAV peripheral information may include a peripheral video of the UAVm captured by a camera installed in the store Fo or the base Pm. The peripheral video may include, for example, an obstacle that may obstruct take-off and landing of the UAVm. Moreover, the monitoring task management server MS may regularly or irregularly receive the weather of an area where the UAVm is located as the UAV peripheral information from a weather management server via the communication network NW.

### [1-1. Configuration and Function of Monitoring Task Management Server MS]

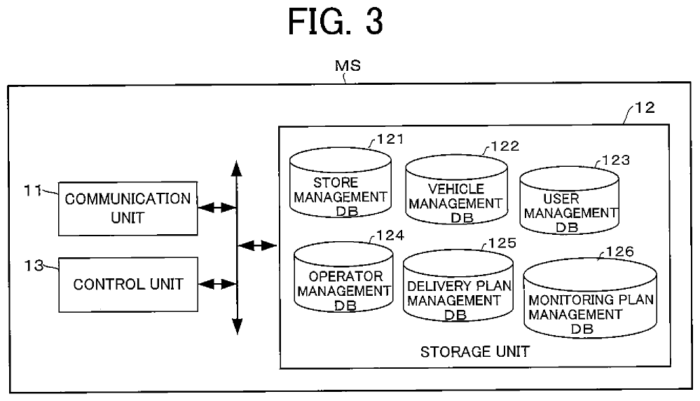

Next, a configuration and a function of the monitoring task management server MS will be described with reference to FIG. 3. FIG. 3 is a diagram illustrating a schematic configuration example of the monitoring task management server MS. As illustrated in FIG. 3, the monitoring task management server MS includes a communication unit 11, a storage unit 12, a control unit 13, and the like. The communication unit 11 controls communication performed via the communication network NW. The communication unit 11 receives information on the order from the order processing server PS. Moreover, the communication unit 11 receives at least one of the UAV information and the UAV peripheral information from the UAVm or the like. The storage unit 12 includes, for example, a hard disk drive or the like, and stores an operating system, various programs including an application, and the like. Here, the application includes a program for performing a flight control information setting method. Moreover, the storage unit 12 includes a buffer memory that sequentially updates and accumulates at least one of the UAV information and the UAV peripheral information received from the UAVm in association with a vehicle ID of the UAVm (identification information of the UAVm) for each UAVm.

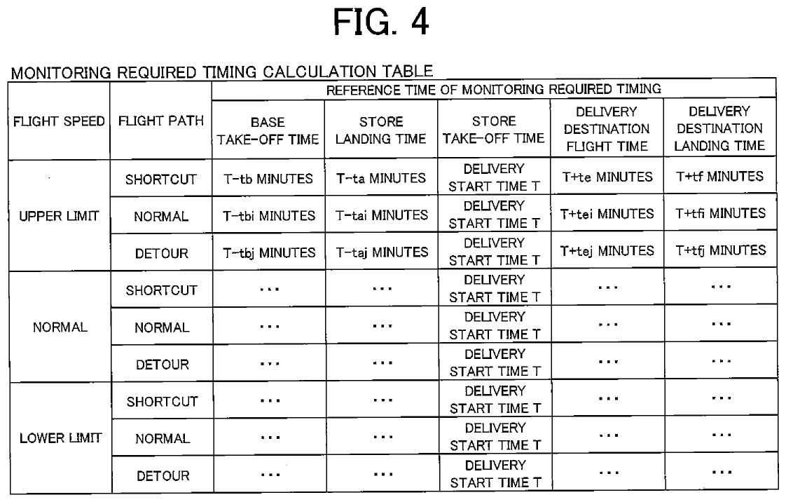

Moreover, the storage unit 12 stores a monitoring required timing calculation table. FIG. 4 is a diagram illustrating an example of the monitoring required timing calculation table. As illustrated in FIG. 4, in the monitoring required timing calculation table, reference times of a plurality of monitoring required timings are registered in association with each flight speed (an upper limit, a normal, and a lower limit) and each flight path (a shortcut, a normal, and a detour). Here, the reference time of the monitoring required timing is a time for calculating the monitoring required timing. The monitoring required timing changes according to a change in at least one of the flight speed of the UAVm and the flight path thereof. The flight speed (scheduled speed) is divided into three sections of the upper limit (for example, 20 m/s), the normal (for example, 13 m/s), and the lower limit (for example, 1 m/s), but may be divided into two or four or more sections.

In the example of FIG. 4, the flight path (the flight route) is divided into three sections of the shortcut, the normal, and the detour, but may be divided into two or four or more sections. The shortcut indicates, for example, that the UAVm flies from one point to another point on a path with the shortest flight distance. The detour indicates, for example, that the UAVm flies from one point to another point on a path with the longest flight distance. For example, the normal indicates that the UAVm flies from one point to another point on a path longer than the flight distance of the shortcut and shorter than the flight distance of the detour. Incidentally, the flight path is determined, for example, when the base Pm, the store Fo, and the delivery destination are determined (that is, when the order is received).

Moreover, when the flight speed of the UAVm is fixed to any one of the upper limit, the normal, and the lower limit, the required time in a case where the UAVm flies on the flight path of the shortcut is set to be earlier by predetermined minutes (for example, 10 minutes) than the required time in a case where the UAVm flies on the flight path of the normal (which may include hovering). Similarly, the required time in a case where the UAVm flies on the flight path of the normal is set to be earlier by predetermined minutes (for example, 10 minutes) than the required time in a case where the UAVm flies on the flight path of the detour. Incidentally, instead of the monitoring required timing calculation table, a function having at least one of the flight speed and the flight path as an input and having the monitoring required timing as an output may be used.

Moreover, in the examples illustrated in FIG. 4, examples of the monitoring required timing include the base take-off time, the store landing time, the store take-off time, the delivery destination flight time, and the delivery destination landing time (five). Here, the “time” may be “immediately before”. The task types of the monitoring tasks to be performed at the respective monitoring required timings are different from each other. Incidentally, the number of task types may be smaller or larger than the number (five) shown in FIG. 4. Moreover, in a case where the base Pm and the store Fo are at the same place, the base take-off time, the store landing time, and the store take-off time can be combined into the store take-off time.

Here, the store take-off time indicates, for example, a timing at which the UAVm loaded with an item takes off from the store Fo for delivery (this is also referred to as “delivery start”). This timing is set to a delivery start time T (a time point) or a time zone on the basis of the delivery start time T by referring to the reference time associated with this timing. The length of the time zone may be equal to the task required time required for performing the monitoring task at the monitoring required timing (the same applies to other monitoring required timings). Incidentally, in the monitoring required timing calculation table, since the delivery start time T becomes a reference, it is registered as, for example, “0:00”.

The store landing time indicates, for example, a timing at which the UAVm taking off from the base Pm arrives above the store and lands (for example, landing on the rack of the store Fo) (also referred to as the monitoring required timing of the store landing time). A timing in the combination of the flight speed with “the upper limit” and the flight path with “the shortcut” is set to, for example, a time point before “ta” minutes (for example, 10 minutes) from the delivery start time T or a time zone on the basis of the time point by referring to the reference time of the monitoring required timing calculation table. Moreover, a timing in the combination of the flight speed with “the upper limit” and the flight path with “the normal” is set to, for example, a time point before “tai” minutes (for example, 20 minutes) from the delivery start time T or a time zone on the basis of the time point by referring to the reference time of the monitoring required timing calculation table.

Moreover, a timing in the combination of the flight speed with “the upper limit” and the flight path with “the detour” is set to, for example, a time point before “taj” minutes (for example, 30 minutes) from the delivery start time T or a time zone on the basis of the time point by referring to the reference time of the monitoring required timing calculation table. Incidentally, the monitoring required timing of the store landing time in another combination of the flight speed and the flight path is also similarly set by referring to the reference time in the monitoring required timing calculation table.

The base take-off time indicates, for example, a timing at which the UAVm takes off from the base Pm (also referred to as the monitoring required timing of the base take-off time). The timing in the combination of the flight speed with “the upper limit” and the flight path with “the shortcut” is set to, for example, a time point before “tb” minutes from the delivery start time T or a time zone on the basis of the time point by referring to the reference time of the monitoring required timing calculation table. The “tb” minutes are the sum of the “ta” minutes and the required time of “tx” minutes from the base Pm to the store Fo. The “tx” minutes are calculated from the flight speed with “the upper limit” of the UAVm and the flight distance corresponding to the flight path with “the shortcut” from the base Pm to the store Fo. Moreover, the timing in the combination of the flight speed with “the upper limit” and the flight path with “the normal” is set to, for example, a time point before “tbi” minutes from the delivery start time T or a time zone on the basis of the time point by referring to the reference time of the monitoring required timing calculation table. The “tbi” minutes are the sum of the “tai” minutes and the required time of “txi” minutes from the base Pm to the store Fo. The “txi” minutes are calculated from the flight speed with “the upper limit” of the UAVm and the flight distance corresponding to the flight path with “the normal” from the base Pm to the store Fo.

Moreover, the timing in the combination of the flight speed with “the upper limit” and the flight path with “the detour” is set to, for example, a time point before “tbj” minutes from the delivery start time T or a time zone on the basis of the time point by referring to the reference time of the monitoring required timing calculation table. The “tbj” minutes are the sum of the “taj” minutes and the required time of “txj” minutes from the base Pm to the store Fo. The “txj” minutes are calculated from the flight speed with “the upper limit” of the UAVm and the flight distance corresponding to the flight path with “the detour” from the base Pm to the store Fo. Incidentally, the monitoring required timing of the base take-off time in another combination of the flight speed and the flight path is also similarly set by referring to the reference time of the monitoring required timing calculation table.

The delivery destination flight time indicates, for example, a timing at which the UAVm taking off from the store Fo reaches the halfway delivery position (also referred to as the monitoring required timing of the delivery destination flight time). The halfway delivery position is a position of a predetermined ratio (for example, 50%) of the flight path from the store Fo to the delivery destination. The timing in the combination of the flight speed with “the upper limit” and the flight path with “the shortcut” is set to, for example, a time point after “te” minutes from the delivery start time T or a time zone on the basis of the time point by referring to the reference time of the monitoring required timing calculation table. The “te” minutes are the required time from the store Fo to the halfway delivery position. The “te” minutes are calculated from the flight speed with “the upper limit” of the UAVm and the flight distance corresponding to the flight path with “the shortcut” from the store Fo to the halfway delivery position. Moreover, the timing in the combination of the flight speed with “the upper limit” and the flight path with “the normal” is set to, for example, a time point after “tei” minutes from the delivery start time T or a time zone on the basis of the time point by referring to the reference time of the monitoring required timing calculation table. The “tei” minutes are the required time from the store Fo to the halfway delivery position. The “tei” minutes are calculated from the flight speed with “the upper limit” of the UAVm and the flight distance corresponding to the flight path with “the normal” from the store Fo to the halfway delivery position.

Moreover, the timing in the combination of the flight speed with “the upper limit” and the flight path with “the detour” is set to, for example, a time point after “tej” minutes from the delivery start time T or a time zone on the basis of the time point by referring to the reference time of the monitoring required timing calculation table. The “tej” minutes are the required time from the store Fo to the halfway delivery position. The “tej” minutes are calculated from the flight speed with “the upper limit” of the UAVm and the flight distance corresponding to the flight path with “the detour” from the store Fo to the halfway delivery position. Incidentally, the monitoring required timing of the delivery destination flight time in another combination of the flight speed and the flight path is also similarly set by referring to the reference time of the monitoring required timing calculation table.

The delivery destination landing time indicates, for example, a timing at which the UAVm taking off from the store Fo arrives above the delivery destination and lands (also referred to as the monitoring required timing of the delivery destination landing time). The timing in the combination of the flight speed with “the upper limit” and the flight path with “the shortcut” is set to, for example, a time point after “tf” minutes from the delivery start time T or a time zone on the basis of the time point by referring to the reference time of the monitoring required timing calculation table. The “tf” minutes are the required time (flight duration) from the store Fo to the delivery destination. The “tf” minutes are calculated from the flight speed with “the upper limit” of the UAVm and the flight distance corresponding to the flight path with “the shortcut” from the store Fo to the delivery destination. Moreover, the timing in the combination of the flight speed with “the upper limit” and the flight path with “the normal” is set to, for example, a time point after “tfi” minutes from the delivery start time T or a time zone on the basis of the time point by referring to the reference time of the monitoring required timing calculation table. The “tfi” minutes are the required time from the store Fo to the delivery destination. The “tfi” minutes are calculated from the flight speed with “the upper limit” of the UAVm and the flight distance corresponding to the flight path with “the normal” from the store Fo to the delivery destination.

Moreover, the timing in the combination of the flight speed with “the upper limit” and the flight path with “the detour” is set to, for example, a time point after “tfj” minutes from the delivery start time T or a time zone on the basis of the time point by referring to the reference time of the monitoring required timing calculation table. The “tfj” minutes are the required time from the store Fo to the delivery destination. The “tfj” minutes are calculated from the flight speed with “the upper limit” of the UAVm and the flight distance corresponding to the flight path with “the detour” from the store Fo to the delivery destination. Incidentally, the monitoring required timing of the delivery destination landing time in another combination of the flight speed and the flight path is also similarly set by referring to the reference time of the monitoring required timing calculation table.

As described above, the monitoring tasks can be distinguished into a plurality of different task types. For example, the monitoring task of the base take-off time, the monitoring task of the store landing time, the monitoring task of the store take-off time, the monitoring task of the delivery destination flight time, and the monitoring task of the delivery destination landing time are different from each other in task type. However, even in the case of monitoring tasks having different task types, the contents (for example, what to gaze at) of the monitoring tasks may be the same or different from each other.

Furthermore, in the storage unit 12, a store management database (DB) 121, a vehicle management database (DB) 122, a user management database (DB) 123, an operator management database (DB) 124, a delivery plan management database (DB) 125, a monitoring plan management database (DB) 126, and the like are constructed. The store management database 121 is a database for managing information on the store Fo that sells an item. In the store management database 121, for example, a store ID, position information (for example, latitude and longitude) of the store Fo, and the like are stored (registered) in association with each store Fo.

The vehicle management database 122 is a database for managing information on the UAVm used for delivery of an item. In the vehicle management database 122, for example, a vehicle ID of the UAVm, an operation situation, an available time zone, position information of the base Pm in which the UAVm is deployed, and the like are stored in association with each UAVm. The operation situation indicates an operating state (for example, moving for delivery preparation, using for delivery, returning), an unusable state, or a standby state, and is updated as appropriate. The available time zone indicates a date and time zone in which the UAVm can be used for delivery.

The user management database 123 is a database for managing information on a user, the account of which is created as a use member of a delivery service. Here, the user having the created account can order an item to the order processing server PS via the orderer terminal UT as an orderer. In the user management database 123, a user ID, a name, an address, an e-mail address, and a telephone number are stored in association with each user. Incidentally, in the user management database 123, an address or position information of a delivery destination of the item may be registered in advance.

The operator management database 124 is a database for managing information on the operator OPn. In the operator management database 124, for example, an operator ID (identification information of the operator OPn) of the operator OPn, a monitoring schedule of the operator OPn, access information (for example, an IP address) of the operator terminal OTn used by the operator OPn, and the like are stored in association with each operator OPn. The monitoring schedule of the operator OPn includes, for example, at least one of a time zone (date and time zone) in which the operator OPn can perform the monitoring task and a time zone (year, month, day, and time zone) in which the operator OPn cannot perform the monitoring task. The time zone in which the monitoring task is not performable includes, for example, a time zone to which a monitoring task for monitoring another UAVm is already allocated (that is, the time zone in which the monitoring task has already entered), a break time zone, and the like.

The delivery plan management database 125 is a database for managing information on a delivery plan. In the delivery plan management database 125, an order ID, a determined delivery plan, and the like are stored in association with each order (delivery). The delivery plan includes, for example, an item ID of an item to be delivered, a vehicle ID of the UAVm that delivers the item, a delivery schedule of the UAVm, flight control information on the UAVm, and the like. The UAVm indicated in the delivery plan is the UAVm determined to be used for delivery. The delivery schedule includes a deliverable time, a delivery start time, and the like. The flight control information is control information for each section (for example, from the base Pm to the store Fo) corresponding to each monitoring required timing. Incidentally, one delivery corresponds to one order ID and one UAVm. For example, an item related to an order identified by the order ID of “d0001” is delivered by the UAV1, and an item related to an order identified by the order ID of “d0002” is delivered by the UAV2.

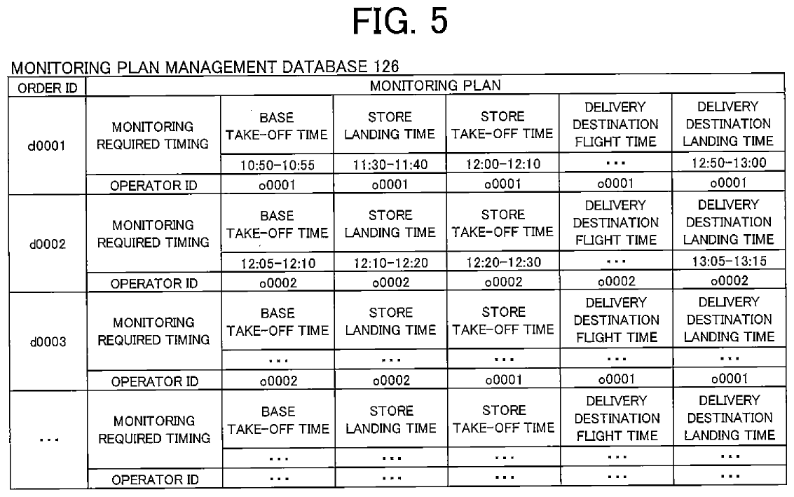

The monitoring plan management database 126 is a database for managing information on a monitoring plan. In the monitoring plan management database 126, an order ID, a determined monitoring plan, and the like are stored in association with each order. Here, the monitoring plan is a plan (in other words, the performance plan of the monitoring task) indicating which operator OPn performs the monitoring task for which UAVm at which monitoring required timing. FIG. 5 is a diagram illustrating examples of the contents of the monitoring plan management database 126. As illustrated in FIG. 5, in the monitoring plan associated with the order ID of “d0001”, the operator ID of the operator OPn who performs the monitoring task is associated with each task type. Moreover, in the monitoring plan, the vehicle ID of the UAVm (the UAVm to be monitored) that requires monitoring at the monitoring required timing may be associated with the operator ID. Incidentally, in the examples of FIG. 5, the monitoring required timing is represented by a time zone (for convenience, date is omitted), and the monitoring task is performed in this time zone (the time zone related to the monitoring required timing).

The control unit 13 includes at least one CPU (Central Processing Unit), a ROM (Read Only Memory), a RAM (Random Access Memory), and the like. The CPU (an example of processor) is configured to access the program code stored in the ROM or the storage unit 12 and operate as instructed by the program code. The program code includes: first acquisition code configured to cause the CPU to acquire the monitoring schedule of the operator OPn who performs the monitoring task for monitoring the UAVm used for delivering the article; second acquisition code configured to cause the CPU to acquire the monitoring required timing at which the UAVm needs to be monitored, the monitoring required timing changing according to a change in at least one of the flight speed of the UAVm and the flight path thereof; and setting code configured to cause the CPU to set at least one of the flight speed of the UAVm and the flight path thereof so as to cause the monitoring required timing to be included in the time zone in which the operator can perform the monitoring task in the monitoring schedule of the operator OPn. The program code further may include change code configured to cause the CPU to, in a case where it is difficult to cause the monitoring required timing of the UAV1 to be included in the time zone in which the operator OPn can perform the monitoring task even if at least one of the flight speed of the UAV1 and the flight path thereof is changed, change the monitoring required timing of the UAV2 by changing at least one of the flight speed of the UAV2 and the flight path thereof, and change, according to a change in the monitoring required timing, the time zone having the monitoring task already allocated thereto and configured to monitor the UAV2 in the monitoring schedule. Moreover, the program code further may include allocation code configured to cause the CPU to allocate, to the time zone, the monitoring task to be performed at the monitoring required timing included in the time zone in which the monitoring task is performable in the monitoring schedule of the operator OPn by setting at least one of the flight speed and the flight path. Moreover, the program code further may include delay control code configured to cause the CPU to delay, in a case where a delay occurs in the delivery schedule of the UAV1, the monitoring required timing of the UAV1. Moreover, the program code further may include flight control code configured to cause the CPU to control flight of the UAVm on the basis of at least one of the set flight speed of the UAVm and the set flight path thereof. Moreover, the program code further may include presentation code configured to cause the CPU to present, to the delivery requester of the article, a predetermined number of deliverable time frames of the article by the UAVm in a selectable manner. Moreover, the program code further may include transmission code configured to cause the CPU to transmit, to the operator terminal OTn, information for causing the operator OPn to perform the monitoring task to be performed at the monitoring required timing in response to arrival of the monitoring required timing.

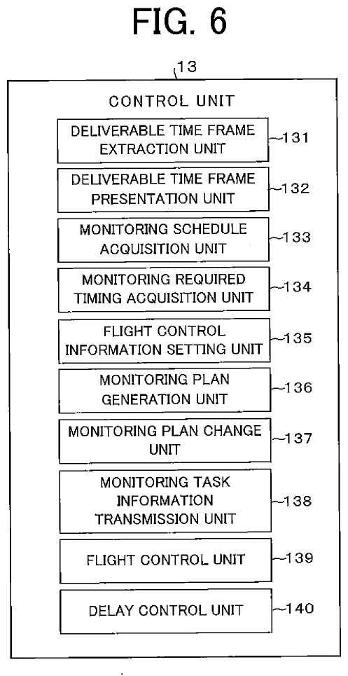

FIG. 6 is a diagram illustrating functional block examples in the control unit 13. As illustrated in FIG. 6, the control unit 13 functions as, for example, a deliverable time frame extraction unit 131, a deliverable time frame presentation unit 132, a monitoring schedule acquisition unit 133, a monitoring required timing acquisition unit 134, a flight control information setting unit 135, a monitoring plan generation unit 136, a monitoring plan change unit 137, a monitoring task information transmission unit 138, a flight control unit 139, a delay control unit 140, and the like in accordance with the program (a program code group) stored in the ROM or the storage unit 12.

For example, when information related to an order is received, the deliverable time frame extraction unit 131 extracts a predetermined number (for example, three or more) of deliverable time frames of an item related to the order on the basis of an estimated time required for delivery of the item related to the order. Here, the estimated time required for the delivery of the item is estimated from a preparation time for picking up and loading the item, a required time for the UAVm to reach a delivery destination, and the like. The required time is calculated from, for example, the flight speed of the UAVm and the flight path corresponding to the flight path from the base Pm of the UAVm to the delivery destination. At this time, for example, the required time is calculated for each of the combinations of the flight speed and the flight path illustrated in FIG. 4, and a plurality of the estimated times including each required time are calculated. Incidentally, in extracting the deliverable time frame, the available time zone of the UAVm managed in the vehicle management database 122 may be appropriately referred to.

The deliverable time frame extraction unit 131 calculates, among the plurality of calculated estimated times, the earliest deliverable time (12:00) on the basis of the shortest estimated time (for example, 20 minutes) (for example, a time at which the UAVm can depart from the store Fo is set as a starting point), and calculates the latest deliverable time (13:00) on the basis of the longest estimated time (for example, 80 minutes). Then, the deliverable time frame extraction unit 131 extracts the deliverable time frame including the latest deliverable time from the earliest deliverable time. Here, the earliest deliverable time corresponds to, for example, the estimated time including the required time in the combination of the flight speed with “the upper limit” and the flight path with “the shortcut” illustrated in FIG. 4B. On the other hand, the latest deliverable time corresponds to the estimated time including the required time in the combination of the flight speed with “the lower limit” and the flight path with “the detour” illustrated in FIG. 4B.

For example, in a case where “12:00 (the starting point) to 13:00 (the ending point)” is extracted as the deliverable time frame, one or more deliverable time frames delayed by a predetermined time from the deliverable time frame may be further extracted. For example, when the predetermined time is 60 minutes, the deliverable time frame is extracted, such as “13:00 to 14:00”, “14:00 to 15:00”, . . . , and the like. Some of such a plurality of deliverable time frames may overlap with each other. In this case, a plurality of deliverable time frames are extracted, for example, such as “12:00 to 13:00”, “12:30 to 13:30”, and “13:00 to 14:00”. Incidentally, the extracted deliverable time frame is associated with the order ID and the UAVm (the vehicle ID) capable of delivering the item to the delivery destination within the deliverable time in the deliverable time frame.

The deliverable time frame presentation unit 132 performs control to present (that is, the deliverable time frame of the item is displayed on the orderer terminal UT of the orderer), to the orderer of the item, a predetermined number of deliverable time frames of the item by the UAVm (the deliverable time frames extracted by the deliverable time frame extraction unit 131) such that the orderer can select the deliverable time frame thereof. The presentation of the deliverable time frame is performed by allowing the order processing server PS to transmit information indicating the deliverable time frame provided by the deliverable time frame presentation unit 132 to the orderer terminal UT. Incidentally, the deliverable time frame presentation unit 132 may directly transmit the information indicating the deliverable time frame from the monitoring task management server MS to the orderer terminal UT without passing through the order processing server PS.

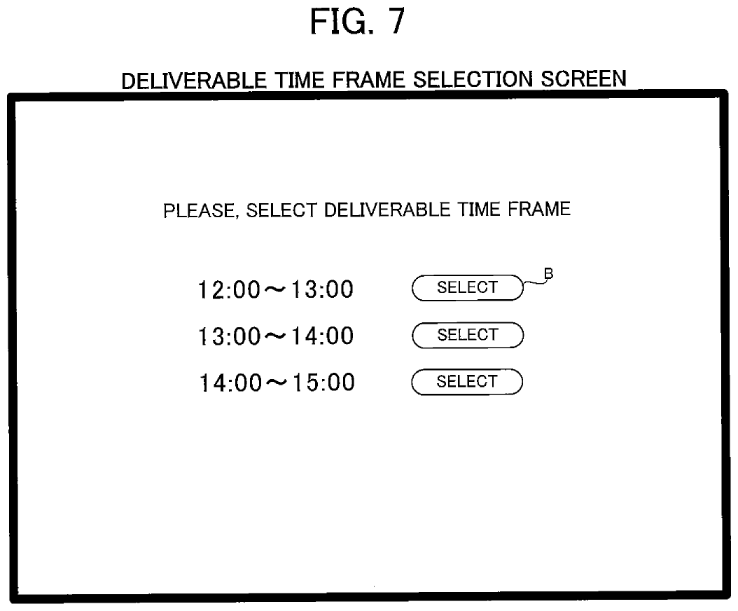

FIG. 7 is a diagram illustrating an example of the deliverable time frame selection screen displayed on the orderer terminal UT. On the deliverable time frame selection screen illustrated in FIG. 7, “12:00 to 13:00”, “13:00 to 14:00”, and “14:00 to 15:00” are displayed as the deliverable time frames. For example, when the orderer designates a button B indicating “select” associated with the “12:00 to 13:00”, the display content of the button B changes to “selecting”. Then, information (for example, the order ID is included) indicating the selected deliverable time frame is transmitted from the orderer terminal UT to the monitoring task management server MS via the order processing server PS.

For example, when the information indicating the deliverable time frame selected by the orderer is received, the monitoring schedule acquisition unit 133 acquires the monitoring schedule of each of the plurality of operators On from the operator management database 124. The monitoring required timing acquisition unit 134 acquires a monitoring required timing, which is a monitoring required timing at which monitoring of the UAVm is required. Here, the monitoring required timing changes according to a change in at least one of the flight speed and the flight path of the UAVm. That is, the monitoring required timing acquisition unit 134 acquires the monitoring required timing frame (range) including a plurality of monitoring required timings from the shortest monitoring required timing to the longest monitoring required timing. Here, the shortest monitoring required timing is, for example, a monitoring required timing corresponding to the combination of the flight speed with “the upper limit” and the flight path with “the shortcut”. On the other hand, the longest monitoring required timing is, for example, a monitoring required timing corresponding to the combination of the flight speed with “the lower limit” and the flight path with “the detour”. Incidentally, the monitoring required timing frame may be acquired for each task type (for example, the monitoring task of the base take-off time, the monitoring task of the store landing time, and the like).

More specifically, the monitoring required timing acquisition unit 134 acquires the monitoring required timing frame configured to require monitoring of the UAVm associated with the deliverable time frame on the basis of the deliverable time frame selected by the orderer and the monitoring required timing calculation table. For example, the delivery start time T is calculated for each combination from the deliverable time (for example, the earliest deliverable time “12:00”) included in the deliverable time frame extracted by the deliverable time frame extraction unit 131 and the required time (for example, the “tf” minutes) from the store Fo to the delivery destination. The calculated delivery start time T is associated with the order ID and the deliverable time.

Then, the calculated delivery start time T is applied to the monitoring required timing calculation table for each of the combinations, whereby the monitoring required timing is acquired for each of the combinations. As a result, the monitoring required timing frame including the monitoring required timing for each of the combinations is acquired (for example, acquisition is performed for each task type). Incidentally, instead of the monitoring required timing calculation table, a function having at least one of the flight speed and the flight path as an input and having the monitoring required timing as an output may be used.

The flight control information setting unit 135 sets (for example, setting is performed for each task type) at least one of the flight speed and the flight path of the UAVm such that the monitoring required timing within the monitoring required timing frame acquired by the monitoring required timing acquisition unit 134 is included in the time zone in which the operator OPn can perform the monitoring task in the monitoring schedule acquired by the monitoring required timing acquisition unit 134. That is, the flight control information setting unit 135 sets at least one of the flight speed and the flight path of the UAVm such that the UAVm can deliver (that is, makes a delivery of) the item in the deliverable time frame selected by the orderer, and the monitoring required timing within the monitoring required timing frame is included in the time zone in which the operator OPn can perform the monitoring task. Accordingly, it is possible to appropriately adjust the monitoring required timing for delivering the article at the desired time of the orderer and causing the operator OPn to perform the monitoring task.

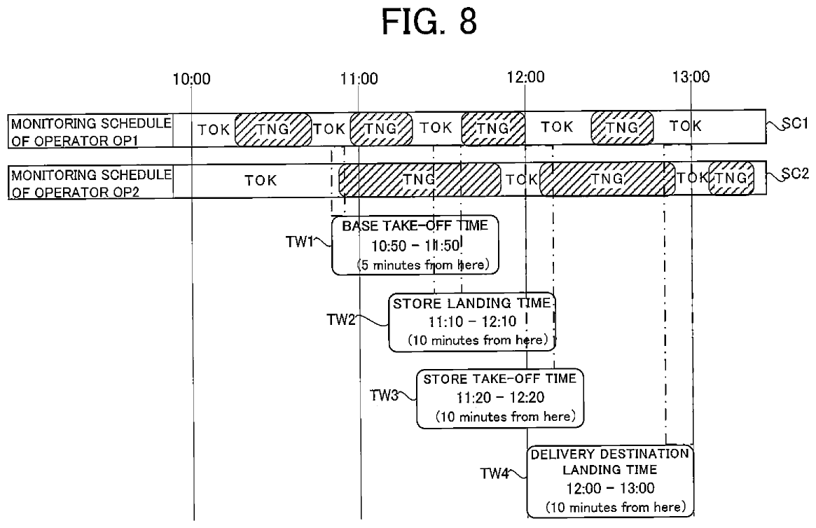

FIG. 8 is a conceptual diagram illustrating a temporal relationship between the monitoring schedules SC1 and SC2 of the operators O1 and O2 and monitoring required timing frames TW1 to TW4 for each task type. In each of the monitoring schedules SC1 and SC2, a time zone TOK in which each of the operators O1 and O2 can perform the monitoring task and a time zone TNG in which each of the operators O1 and O2 cannot perform the monitoring task are illustrated. For example, at least one of the flight speed and the flight path is set such that the monitoring required timing (in this example, 12:50 to 13:00 for 10 minutes) in the monitoring required timing frame TW4 “12:00 to 13:00” of the delivery destination landing time is included in the time zone TOK in which the operator OP1 can perform the monitoring task in the monitoring schedule SC1. Moreover, at least one of the flight speed and the flight path is set such that the monitoring required timing (in this example, 12:00 to 12:10 for 10 minutes) in the monitoring required timing frame TW3 “11:20 to 12:20” of the store take-off time is included in the time zone TOK in which operator OP1 can perform the monitoring task in the monitoring schedule SC1. Similar setting is performed for the monitoring required timing frames TW1 and TW2 of other task types.

More specifically, the flight control information setting unit 135 performs setting such that the monitoring required timing of each of the monitoring required timing frames TW1 to TW4 is included in the time zone TOK in which the operator OP1 can perform the monitoring task by changing at least one of the flight speed and the flight path of the UAVm (calculation to virtually change at least one thereof in the flight control information setting unit 135). For example, in a case where the monitoring required timing is advanced to be included in the time zone TOK in which the monitoring task can be performed, the flight control information setting unit 135 changes the flight speed such that the flight speed of the UAVm is increased, or changes the flight path such that the flight path of the UAVm is shortened. Accordingly, the monitoring required timing can be advanced. Alternatively, in a case where the monitoring required timing is advanced to be included in the time zone TOK in which the monitoring task can be performed, the flight control information setting unit 135 changes the flight speed such that the flight speed of the UAVm is increased, and changes the flight path such that the flight path of the UAVm is shortened. Accordingly, it is possible to further advance the monitoring required timing.

On the other hand, in a case where the monitoring required timing is delayed to be included in the time zone TOK in which the monitoring task can be performed, the flight control information setting unit 135 changes the flight speed such that the flight speed of the UAVm becomes slower, or changes the flight path such that the flight path of the UAVm becomes longer. Accordingly, the monitoring required timing can be delayed. Alternatively, in a case where the monitoring required timing is delayed to be included in the time zone TOK in which the monitoring task can be performed, the flight control information setting unit 135 changes the flight speed such that the flight speed of the UAVm becomes slower, and changes the flight path such that the flight path of the UAVm becomes longer. Accordingly, the monitoring required timing can be further delayed.

Incidentally, when it is difficult (impossible) to include the monitoring required timing of the UAVm in the time zone in which the monitoring task can be performed, the flight control information setting unit 135 may perform setting such that the monitoring required timing is included in the time zone in which the monitoring task can be performed by changing the flight path of the UAVm. As a result, it is possible to more efficiently adjust the monitoring required timing for causing the operator OPn to perform the monitoring task. This is based on the idea that the control for changing the flight speed of the UAVm is more efficient from the viewpoint of power consumption and the like than the control for changing the flight path of the UAVm.

Incidentally, in the example of FIG. 8, at least one of the flight speed and the flight path of the UAVm is set such that the monitoring required timing of each of the monitoring required timing frames TW1 to TW4 is included in the time zone TOK in which the operator OP1 can perform the monitoring task in the monitoring schedule SC1 of the operator OP1. As a result, it is possible to appropriately adjust a plurality of monitoring required timings for causing one operator OP1 to perform a plurality of monitoring tasks for monitoring one UAVm. As another example, the flight control information setting unit 135 may set at least one of the flight speed and the flight path of the UAVm such that the monitoring required timings in some monitoring required timing frames (for example, TW1 and TW2) among the monitoring required timing frames TW1 to TW4 are included in the time zone TOK in which the operator OP1 can perform the monitoring task in the monitoring schedule SC1 of the operator OP1. In this case, the flight control information setting unit 135 sets at least one of the flight speed and the flight path of the UAVm such that the monitoring required timings in the remaining monitoring required timing frames (for example, TW3 and TW4) among the monitoring required timing frames TW1 to TW4 are included in the time zone TOK in which the operator OP2 can perform the monitoring task in the monitoring schedule SC2 of the operator OP2.

The monitoring plan generation unit 136 generates (determines) the monitoring plan by allocating, to the time zone, the monitoring task to be performed at the monitoring required timing that is included in the time zone in which the monitoring task can be performed in the monitoring schedule of the operator OP1 by setting at least one of the flight speed and the flight path by using the flight control information setting unit 135. For example, by allocating the monitoring task to be performed at the monitoring required timing of each of the monitoring required timing frames TW1 to TW4 of the UAV1 to the monitoring schedule of the operator OP1, the monitoring task to be performed at each monitoring required timing can be performed more efficiently by one operator OP1 (the operator ID of “00001”) in one go (a single pass) (for example, refer to the order ID of “d0001” illustrated in FIG. 5). As described above, when the monitoring plan corresponding to the deliverable time frame selected by the orderer is determined, the delivery plan for the order is determined. Incidentally, for example, in the monitoring schedule of the operator OP1, for example, a monitoring task for monitoring another UAV2 deployed in the base P2 different from the base P1 of the UAV1 may be already allocated. As a result, it is possible to cause one operator OP1 to efficiently perform the monitoring task to be performed at the monitoring required timing of the UAVm deployed at each of the plurality of bases Pm.

Alternatively, the monitoring plan generation unit 136 may allocate, to the time zone, the monitoring task to be performed at the monitoring required timing (for example, each of the monitoring required timings of the monitoring required timing frames TW1 and TW2) that is included in the time zone in which the monitoring task can be performed in the monitoring schedule of the operator OP1, and allocate, to the time zone, the monitoring task to be performed at another monitoring required timing (for example, each of the monitoring required timings of the monitoring required timing frames TW3 and TW4) that is included in the time zone in which the monitoring task can be performed in the monitoring schedule of the operator OP2, thereby generating the monitoring plan. As a result, the performance burden of the monitoring task to be performed at each monitoring required timing in the monitoring required timing group of one UAVm can be distributed to a plurality of operators On.

Alternatively, the operator OPn who performs the monitoring task may be fixed for each task type (that is, complete division of work for each task type). In this case, for example, the monitoring plan generation unit 136 allocates the monitoring task (for example, the monitoring task of the store take-off time) of the first task type of each of the UAV1 and the UAV2 included in the time zone in which the monitoring task can be performed in the monitoring schedule of the operator OP1, and allocates the monitoring task (for example, the monitoring task of the delivery destination landing time) of the second task type of each of the UAV1 and the UAV2 included in the time zone in which the monitoring task can be performed in the monitoring schedule of the operator OP2, thereby generating the monitoring plan. As a result, the monitoring task to be performed at the monitoring required timing of each of the plurality of UAVms can be divided into the plurality of operators On for each task type. Therefore, the expertise of the monitoring task for each task type can be enhanced, thereby making it possible to allow the operator OPn to more appropriately perform the monitoring task.

Even when at least one of the flight speed and the flight path of the UAV1 is changed by the flight control information setting unit 135, for example, since the monitoring schedule of the operator OP1 includes the time zone to which the monitoring task for monitoring the UAV2 is already allocated, it is assumed that it is difficult (impossible) to include the monitoring required timing of the UAV1 in the time zone in which the operator OP1 can perform the monitoring task. In this case, the monitoring plan change unit 137 changes the monitoring required timing of the UAV2 in the monitoring required timing frame including the monitoring required timing by changing at least one of the already set flight speed and flight path of the UAV2. Further, the monitoring plan change unit 137 changes the time zone to which the monitoring task for monitoring the UAV2 is already allocated in the monitoring schedule of the operator OP1 according to the change of the monitoring required timing of the UAV2 (changed to the time zone in which the operator OP1 can perform the monitoring task).

Then, the flight control information setting unit 135 sets at least one of the flight speed and the flight path of the UAV1 such that the monitoring required timing in the monitoring required timing frame of the UAV1 is included in an idle time zone generated by allowing the monitoring plan change unit 137 to change the time zone. As a result, even in a case where it is difficult to include the monitoring required timing of the UAV1 in the time zone in which the operator OP1 can perform the monitoring task, the monitoring required timing for causing the operator OP1 to perform the monitoring task that requires monitoring of the UAV1 can be appropriately adjusted by appropriately changing the monitoring required timing of the UAV2.

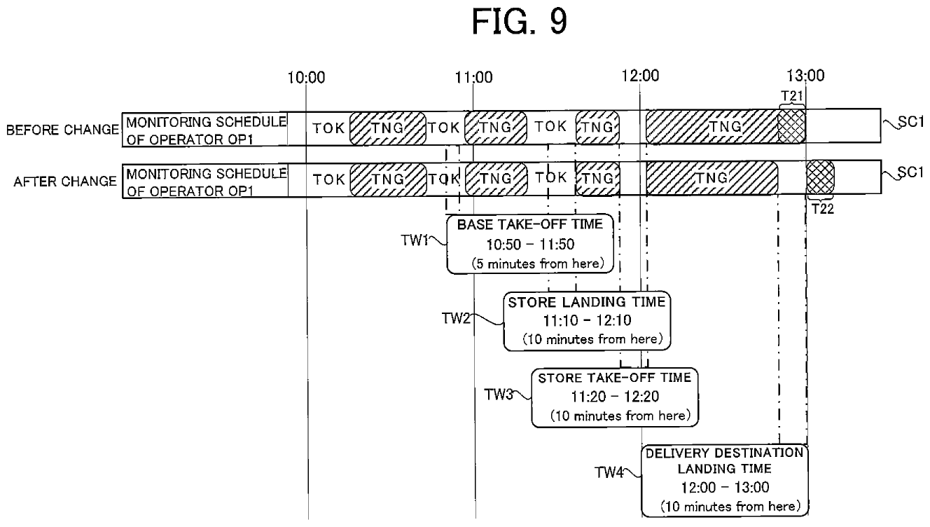

FIG. 9 is a conceptual diagram illustrating an example in which the time zone to which the monitoring task for monitoring the UAV2 is already allocated is changed. In the example of FIG. 9, a time zone T21 “12:50 to 13:00” to which the monitoring task for monitoring the UAV2 is already allocated in the monitoring schedule SC1 of the operator OP1 is changed to a time zone T22 “13:00 to 13:10”, so that the time zone T21 is generated as an idle time zone. It is confirmed before the change that the time zone T21 corresponds to the monitoring required timing included in the monitoring required timing frame TW4 of the UAV2. Then, at least one of the flight speed and the flight path of the UAV1 is set such that the monitoring required timing in the monitoring required timing frame TW4 of the UAV1 is included in the idle time zone T21 generated by the change. In this way, the monitoring task to be performed at the monitoring required timing of the UAV1, which is included in the idle time zone T21 in the monitoring schedule of the operator OP1, is allocated to the time zone T21.

The monitoring task information transmission unit 138 transmits (for example, push delivery) information (hereinafter, referred to as “monitoring task information”) for causing the operator OPn to perform the monitoring task to be performed at the monitoring required timing to the operator terminal OTn used by the operator OPn according to the arrival of the monitoring required timing of the UAVm to be monitored. As a result, it is possible to cause the operator OPn to quickly and appropriately perform the monitoring task to be performed at the monitoring required timing of the UAVm. Incidentally, “According to the arrival of the monitoring required timing” means a case in which the current time becomes a starting point of the time zone related to the monitoring required timing or a case in which the current time becomes several seconds before the starting point. The monitoring task information may include a message prompting the operator OPn to perform the monitoring task. Such a message may include information indicating the contents of the monitoring task. Moreover, the monitoring task information may include a control command for causing the operator terminal OTn to display (for example, pop-up) a monitoring task performance screen.

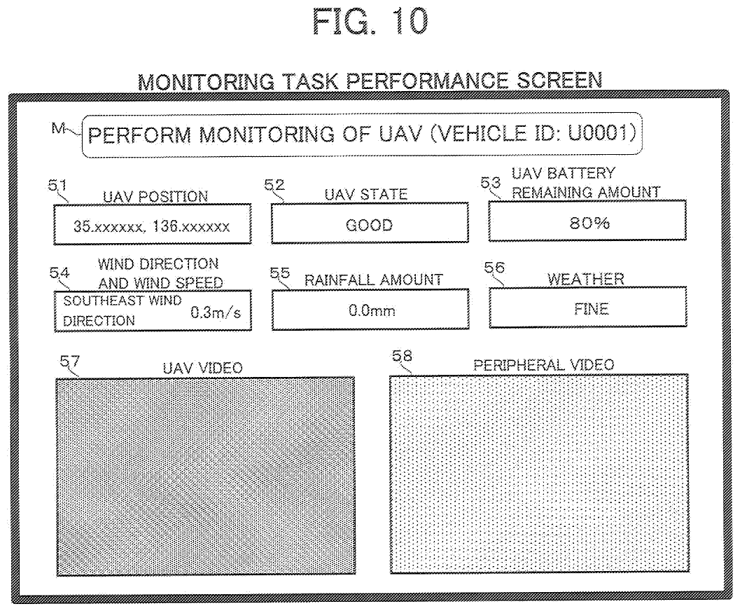

FIG. 10 is a diagram illustrating an example of the monitoring task performance screen displayed on the operator terminal OT1. On the monitoring task performance screen illustrated in FIG. 10, UAV information on the UAV1 to be monitored and UAV peripheral information on the peripheral situation of the UAV1 are displayed, and a message M prompting the operator OP1 to perform the monitoring task is displayed. The UAV information and the UAV peripheral information are sequentially received from the monitoring task management server MS. As illustrated in FIG. 10, the position of the UAV1 is displayed in a UAV position display area 51. In a UAV state display area 52, the state of the UAV1 is displayed. The remaining battery amount of the UAV1 is displayed in a UAV battery display area 53. Incidentally, a monitoring task performance screen different for each task type may be displayed.

In a wind direction and wind speed display area 54, a wind direction and a wind speed detected by a weather sensor installed in the store Fo or the base P1 where the UAV1 is located are displayed. In a rainfall amount display area 55, a rainfall amount detected by the weather sensor installed in the store Fo or the base P1 where the UAV1 is located is displayed. A weather display area 56 displays the weather of the area where the UAV1 is located. In a UAV camera video display area 57, a UAV video captured by a camera of the UAV1 is displayed. In a peripheral camera video display area 58, a peripheral video of the UAV1 captured by a camera installed in the store Fo or the base P1 where the UAV1 is located is displayed. The operator OP1 performs the monitoring task while viewing the information displayed on the monitoring task performance screen.

The flight control unit 139 indirectly controls the flight of the UAVm on the basis of at least one of the flight speed and the flight path of the UAVm set by the flight control information setting unit 135. For example, the flight control unit 139 transmits flight control information including at least one of the flight speed and the flight path of the UAVm to the UAV1m via the communication unit 11. For example, the flight control information for each section corresponding to each monitoring required timing indicated in the determined monitoring plan is transmitted to the UAV1m. As a result, it is possible to appropriately control the flight of the UAVm in order to cause the operator OPn to perform the monitoring task at the set monitoring required timing.

Meanwhile, in a case where a delay occurs in a delivery schedule due to, for example, the state of the UAV1, the peripheral situation, or the like in which the delivery schedule is determined, the delay control unit 140 delays the monitoring required timing of the UAV1. That is, the delay control unit 140 updates (changes) the monitoring required timing of the UAV1 in the monitoring plan registered in the monitoring plan management database 126 so as to delay the monitoring required timing of the UAV1 according to the delay time of the delivery schedule of the UAV1. Further, the delay control unit 140 updates (changes) the time zone to which the monitoring task is allocated in the monitoring schedule of the operator OP1 who performs the monitoring task at the changed monitoring required timing so as to delay the time zone according to the delay time of the delivery schedule of the UAV1.

In a case where the monitoring required timing of the UAV1 is delayed in this manner, in a case where a monitoring task for monitoring the UAV2, for example, other than the UAV1 is allocated to the monitoring schedule of the operator OP1, the delay control unit 140 determines whether at least a part of the monitoring required timing after the delay of the UAV1 and at least a part of the monitoring required timing of the UAV2 overlap with each other. Then, in a case where at least a part of the monitoring required timing after the delay of the UAV1 and at least a part of the monitoring required timing of the UAV2 overlap with each other, the flight control information setting unit 135 resets at least one of the flight speed and the flight path of the UAV2 such that the monitoring required timing in the monitoring required timing frame of the UAV2 is included in the time zone in which the monitoring task can be performed in the monitoring schedule of the operator OP1. The resetting method is similar to the setting method described above. As a result, even in a case where at least a part of the monitoring required timing after the delay of the UAV1 and at least a part of the monitoring required timing of the UAV2 overlap with each other due to occurrence of the delay in the delivery schedule of the UAV1, the monitoring required timing for causing the operator OP1 to perform the monitoring task of each of the UAV1 and the UAV2 can be appropriately adjusted. By performing the resetting in this way, the monitoring plan is changed by allocating, to the time zone, the monitoring task to be performed at the monitoring required timing included in the time zone in which the monitoring task can be performed in the monitoring schedule of the operator OP1.

However, by changing at least one of the flight speed and the flight path of the UAV2, it is assumed that the monitoring required timing of the UAVm cannot be included in the time zone in which the operator OP1 can perform the monitoring task. In this case, the delay control unit 140 may change the monitoring plan by allocating the monitoring task to be performed at the monitoring required timing of the UAV2 to the time zone in which the monitoring task can be performed in the monitoring schedule of another operator OPn other than the operator OP1. That is, the monitoring task to be performed at the monitoring required timing of the UAV2 is replaced (i.e., shifted) from the operator OP1 to another operator OPn (that is, the monitoring schedule of the operator OPn). As a result, it is possible to cause the operator OPn to appropriately perform the monitoring task to be performed at the monitoring required timing of each of the UAV1 and the UAV2.

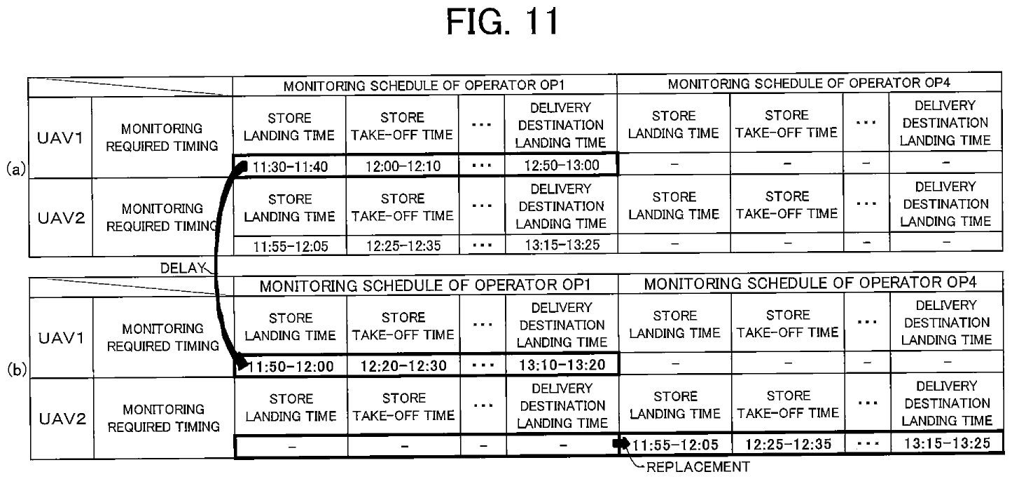

FIG. 11 is a conceptual diagram illustrating an example in which the monitoring task to be performed at the monitoring required timing of the UAV2 is replaced from the monitoring schedule of the operator OP1 to the monitoring schedule of the operator OP4. In the example of FIG. 11, when a delay occurs in the determined delivery schedule of the UAV1, the monitoring required timing “11:30 to 11:40” corresponding to the store landing time is changed to “11:50 to 12:00”, the monitoring required timing “12:00 to 12:10” corresponding to the store take-off time is changed to “12:20 to 12:30”, and the monitoring required timing “12:50 to 13:00” corresponding to the delivery destination landing time is changed to “13:10 to 13:20”. Therefore, since at least a part of the monitoring required timing after the delay of the UAV1 and at least a part of the monitoring required timing of the UAV2 overlap with each other, the monitoring task to be performed at the monitoring required timing of the UAV2 is replaced (shifted) from the monitoring schedule of the operator OP1 to the monitoring schedule of the operator OP4.

Incidentally, in a case where there is no operator OPn who can replace the monitoring task to be performed at the monitoring required timing of the UAV2, the delay control unit 140 may notify the orderer of a message indicating delivery cancellation. The notification of such a message may be performed by transmitting an e-mail describing the message to the e-mail address of the orderer, or may be performed by transmitting the message to the phone number of the orderer by SMS. Alternatively, the notification of the message may be performed by pushing and delivering the message to a notification application resident in the orderer terminal UT of the orderer.

### [2. Operation of Delivery Management System S]

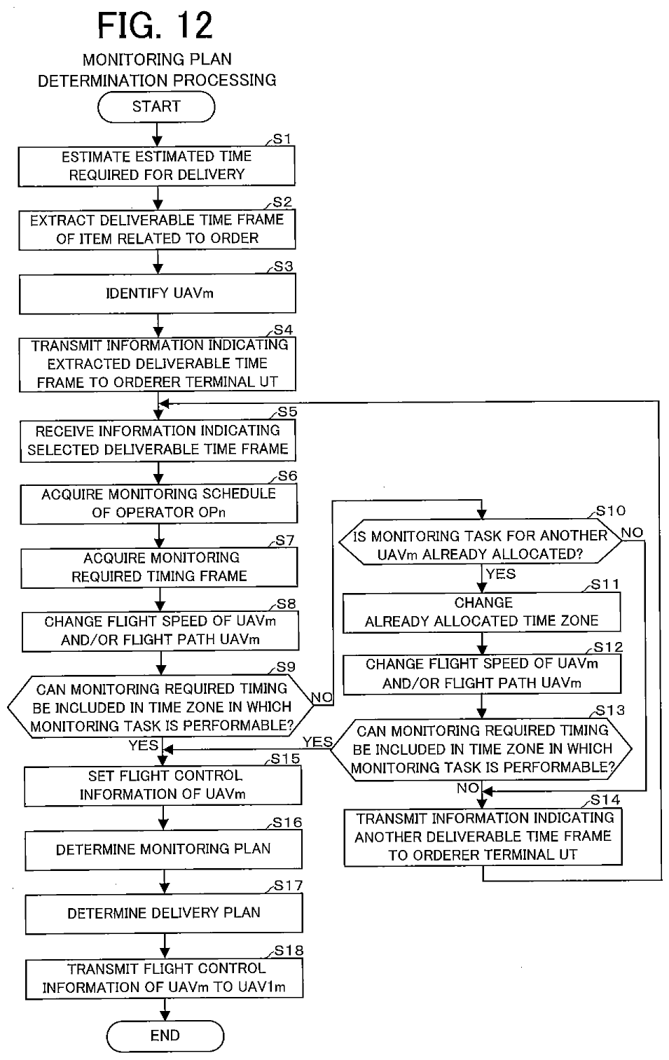

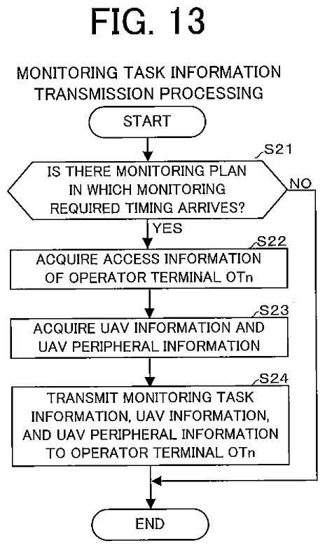

Next, the operation of the delivery management system S will be described with reference to FIGS. 12 to 13. FIG. 12 is a flowchart illustrating an example of monitoring plan determination processing of the control unit 13 in the monitoring task management server MS. FIG. 13 is a flowchart illustrating an example of monitoring task information transmission processing of the control unit 13 in the monitoring task management server MS.

### (2-1. Monitoring Plan Determination Processing)

First, as a premise of the processing illustrated in FIG. 12, it is assumed that an order from the orderer terminal UT is received by the order processing server PS. The processing illustrated in FIG. 17 is started, for example, when information on the order is received from the order processing server PS by the monitoring task management server MS.

When the processing illustrated in FIG. 12 is started, the control unit 13 estimates an estimated time required for the delivery of an item related to the order as described above on the basis of the received information on the order (step S1).

Next, the control unit 13 extracts a plurality of (for example, three) deliverable time frames of the item related to the order by the deliverable time frame extraction unit 131 as described above on the basis of the estimated time and the like estimated in step S1 (step S2).

Next, the control unit 13 refers to the vehicle management database 122 (that is, refer to the available time zone of each UAVm, and the like), and identifies one UAVm that can deliver the item to the delivery destination at the deliverable time for each deliverable time frame extracted in step S2 (step S3). The UAVm (the vehicle ID) accordingly identified is associated with the order ID included in the information on the order and the deliverable time frame extracted in step S2.

Next, the control unit 13 causes the deliverable time frame presentation unit 132 to transmit the information indicating the deliverable time frame extracted in step S2 to the orderer terminal UT of the orderer (step S4). As a result, a plurality of deliverable time frames are selectably displayed on the orderer terminal UT. Then, when any one of the deliverable time frames displayed on the orderer terminal UT is selected by the orderer, information (for example, the order ID is included) indicating the selected deliverable time frame is transmitted to the monitoring task management server MS. Accordingly, the received order is confirmed.

Next, when receiving the information indicating the deliverable time frame selected by the orderer (step S5), the control unit 13 causes the monitoring schedule acquisition unit 133 to acquire the monitoring schedule of each of the plurality of operators On from the operator management database 124 (step S6).

Next, on the basis of the deliverable time frame indicated in the information received in step S5 and the monitoring required timing calculation table stored in the storage unit 12, the control unit 13 acquires the monitoring required timing frame required to monitor the UAVm associated with the deliverable time frame by the monitoring required timing acquisition unit 134 as described above (step S7). Such a monitoring required timing frame is acquired, for example, for each task type.

Next, the control unit 13 changes at least one of the flight speed and the flight path of the UAVm such that the monitoring required timing in the monitoring required timing frame acquired in step S7 is included in the time zone in which the operator OPn can perform the monitoring task in the monitoring schedule acquired in step S6 (step S8). Incidentally, the processing of steps S8 to S15 is performed, for example, for each task type.

Next, by changing at least one of the flight speed and the flight path of the UAVm in step S8, the control unit 13 determines whether the monitoring required timing of the UAVm can be included in the time zone in which the operator OPn can perform the monitoring task (step S9). The UAVm is, for example, the UAV1 associated with the deliverable time frame selected by the orderer. When it is determined that the monitoring required timing cannot be included in the time zone in which the operator OPn can perform the monitoring task (step S9: NO), the processing proceeds to step S10. On the other hand, when it is determined that the monitoring required timing can be included in the time zone in which the operator OPn can perform the monitoring task (step S9: YES), the processing proceeds to step S15.

In step S10, the control unit 13 determines whether a monitoring task for monitoring another UAVm (for example, the UAV2) is already allocated to the monitoring schedule acquired in step S6. When it is determined that the monitoring task is already allocated thereto (step S10: YES), the processing proceeds to step S11. On the other hand, when it is determined that the monitoring task is not already allocated thereto (step S10: NO), the processing proceeds to step S14.

In step S11, the control unit 13 changes the time zone to which the monitoring task for monitoring the UAVm is already allocated by changing at least one of the already set flight speed and flight path of another UAVm (for example, the UAV2) in the monitoring required timing frame including the monitoring required timing corresponding to the time zone. Here, the already allocated time zone is changed in the time zone in which the operator OPn can perform the monitoring task. Then, the processing proceeds to step S12.

In step S12, the control unit 13 changes at least one of the flight speed and the flight path of the UAVm such that the monitoring required timing in the monitoring required timing frame acquired in step S7 is included in the time zone (that is, the idle time zone generated by the change of the time zone in step S11) in which the operator OPn can perform the monitoring task.

Next, by changing at least one of the flight speed and the flight path of the UAVm in step S12, the control unit 13 determines whether the monitoring required timing of the UAVm can be included in the time zone in which the operator OPn can perform the monitoring task (step S13). When it is determined that the monitoring required timing cannot be included in the time zone in which the operator OPn can perform the monitoring task (step S13: NO), the processing proceeds to step S14. On the other hand, when it is determined that the monitoring required timing can be included in the time zone in which the operator OPn can perform the monitoring task (step S13: YES), the processing proceeds to step S15.

In step S14, the control unit 13 transmits, to the orderer terminal UT of the orderer, another deliverable time frame different from the deliverable time frame together with the information indicating that delivery of the item is impossible in the deliverable time frame selected by the orderer, and returns to step S5 to perform processing similar to the above-described processing. Here, another deliverable time frame is the deliverable time frame extracted in step S2.

On the other hand, in step S15, the control unit 13 sets the flight control information including at least one of the flight speed and the flight path when the monitoring required timing is included in the time zone in which the operator OPn can perform the monitoring task. The flight control information of the UAVm set in this manner is associated with the vehicle ID of the UAVm and the order ID included in the information on the order.

Next, the control unit 13 generates (determines) the monitoring plan by allocating, to the time zone by the monitoring plan generation unit 136, the monitoring task to be performed at the monitoring required timing that is included in the time zone in which the monitoring task can be performed in the monitoring schedule of the operator OPn (step S16). The monitoring plan accordingly determined is stored in the monitoring plan management database 126 in association with the order ID of the confirmed order.

Next, the control unit 13 determines a delivery plan including the delivery schedule of the UAVm associated with the deliverable time frame selected by the orderer (step S17). The delivery plan accordingly determined and the flight control information set in step S15 are stored in the delivery plan management database 125 in association with the order ID of the confirmed order.

Next, the control unit 13 causes the flight control unit 139 to transmit the flight control information set in step S15 and the delivery schedule to the UAV1m (step S18), and ends the processing illustrated in FIG. 12. As a result, after the UAVm takes off from the base Pm to deliver the ordered item according to the received delivery schedule, the flight control unit of the UAVm directly controls the flight of the UAVm on the basis of at least one of the flight speed and the flight path included in the received flight control information. Incidentally, in the flight speed and the flight path of the UAVm, a parameter that is not included in the flight control information transmitted by the flight control unit 139 may be fixedly set in advance in the UAVm.

### (2-2. Monitoring Task Information Transmission Processing)

Next, as a premise of the processing illustrated in FIG. 13, it is assumed to use a monitoring list for registering the monitoring plan including the monitoring required timing that arrives within a predetermined time (for example, 24 hours) from the current time among the monitoring plans stored in the monitoring plan management database 126. For example, the processing illustrated in FIG. 13 is started at a predetermined cycle (for example, intervals of a few seconds).

When the processing illustrated in FIG. 13 is started, the control unit 13 determines whether there is a monitoring plan in which the monitoring required timing arrives (for example, the starting point of the monitoring required timing has passed the current time) among the monitoring plans registered in the monitoring list (step S21). When it is determined that there is the monitoring plan in which the monitoring required timing has arrived (step S21: YES), the processing proceeds to step S22. On the other hand, when it is determined that there is no monitoring plan in which the monitoring required timing has arrived (step S21: NO), the processing ends.

In step S22, the control unit 13 acquires, for example, the access information of the operator terminal OT1 used by the operator OP1 associated with the monitoring required timing included in the monitoring plan in which the monitoring required timing has arrived, and the vehicle ID of the UAV1 that requires monitoring at the monitoring required timing. Next, the control unit 13 acquires UAV information and UAV peripheral information of the UAV1 identified by the vehicle ID acquired in step S22 from the buffer memory (step S23).

Next, the control unit 13 establishes an access to the operator terminal OT1 via the communication network NW according to the access information acquired in step S22, and transmits the above-described monitoring task information, and the UAV information and the UAV peripheral information acquired in step S23 to the operator terminal OT1 by the monitoring task information transmission unit 136 (step S24). Incidentally, while the access to the operator terminal OT1 is established, the control unit 13 performs control so as to sequentially transmit the UAV information of the UAV1 and the UAV peripheral information thereof to the operator terminal OT1.

Then, when receiving the monitoring task information, the UAV information, and the UAV peripheral information, the operator terminal OT1 displays, for example, the UAV information and the UAV peripheral information of the UAV1 on the monitoring task performance screen together with the message M prompting the operator OP1 to perform the monitoring task, as illustrated in FIG. 10. As a result, the operator OP1 performs the monitoring task for monitoring the UAV1.

According to the above-described embodiment, the monitoring task management server MS acquires the monitoring schedule including the time zone in which the operator OPn can perform the monitoring task, acquires the monitoring required timing (the monitoring required timing of the UAVm) that changes according to a change in at least one of the flight speed and the flight path of the UAVm, and sets at least one of the flight speed and the flight path of the UAVm such that the monitoring required timing of the UAVm is included in the time zone in which the operator OPn can perform the monitoring task in the monitoring schedule of the operator OPn. Therefore, the monitoring required timing for causing the operator OPn to perform the monitoring task can be appropriately adjusted.

Incidentally, the above-described embodiment is one embodiment of the present invention, and the present invention is not limited to the above-described embodiment, changes from the above-described embodiment can be made on various configurations and the like within a scope not departing from the gist of the present invention, and such cases shall be also included in the technical scope of the present invention. In the above-described embodiment, a description has been given, as an example, as to a case in which an orderer orders an item to be sold at the store Fo, but the present invention is also applicable to a case in which an article other than the item is delivered. An example of such a case includes a case in which relief supplies or support supplies requested by a delivery requester are delivered to an evacuation place or the like. Moreover, in the above-described embodiment, the UAV has been described as an example of the unmanned aerial vehicle, but the present invention is also applicable to a flying robot or the like as an example of the unmanned aerial vehicle.

### REFERENCE SIGNS LIST

11 Communication unit
12 Storage unit
13 Control unit
131 Deliverable time frame extraction unit
132 Deliverable time frame presentation unit
133 Monitoring schedule acquisition unit
134 Monitoring required timing acquisition unit
135 Flight control information setting unit
136 Monitoring plan generation unit
137 Monitoring plan change unit
138 Monitoring task information transmission unit
139 Flight control unit
140 Delay control unit
PS Order processing server
MS Monitoring task management server
OTn Operator terminal
UT Orderer terminal
S Delivery management system
NW Communication network

What is claimed is:

1. A flight control information setting device comprising:
at least one memory configured to store program code; and at least one processor configured to access the program code and operate as instructed by the program code, the program code including:
first acquisition code configured to cause the at least one processor to acquire a monitoring schedule of an operator who performs a monitoring task for monitoring an unmanned aerial vehicle used for delivering an article, the monitoring schedule including a time zone in which the operator can perform the monitoring task;
second acquisition code configured to cause the at least one processor to acquire a monitoring required timing at which the unmanned aerial vehicle needs to be monitored, the monitoring required timing changing according to a change in at least one of a flight speed of the unmanned aerial vehicle and a flight path thereof; and
setting code configured to cause the at least one processor to set at least one of the flight speed of the unmanned aerial vehicle and the flight path thereof so as to cause the monitoring required timing to be included in the time zone in which the operator can perform the monitoring task in the monitoring schedule of the operator.

2. The flight control information setting device according to claim 1, wherein the setting code is further configured to cause the at least one processor to, in a case where the monitoring required timing is advanced to be included in the time zone in which the monitoring task is performable, change the flight speed of the unmanned aerial vehicle so as to increase the flight speed or change the flight path of the unmanned aerial vehicle so as to shorten the flight path.

3. The flight control information setting device according to claim 1, wherein the setting code is further configured to cause the at least one processor to, in a case where the monitoring required timing is advanced to be included in the time zone in which the monitoring task is performable, change the flight speed of the unmanned aerial vehicle so as to increase the flight speed and change the flight path of the unmanned aerial vehicle so as to shorten the flight path.

4. The flight control information setting device according to claim 1, wherein the setting code is further configured to cause the at least one processor to, in a case where the monitoring required timing is delayed to be included in the time zone in which the monitoring task is performable, change the flight speed of the unmanned aerial vehicle so as to reduce the flight speed or change the flight path of the unmanned aerial vehicle so as to lengthen the flight path.

5. The flight control information setting device according to claim 1, wherein the setting code is further configured to cause the at least one processor to, in a case where the monitoring required timing is delayed to be included in the time zone in which the monitoring task is performable, change the flight speed of the unmanned aerial vehicle so as to reduce the flight speed and change the flight path of the unmanned aerial vehicle so as to lengthen the flight path.

6. The flight control information setting device according to claim 1, wherein
the second acquisition code is further configured to cause the at least one processor to acquire a plurality of the monitoring required timings, and
the setting code is further configured to cause the at least one processor to set at least one of the flight speed of the unmanned aerial vehicle and the flight path thereof so as to cause the plurality of monitoring required timings to be included in the time zone in which the monitoring task is performable in the monitoring schedule of the operator.

7. The flight control information setting device according to claim 1, wherein the setting code is further configured to cause the at least one processor to set at least one of the flight speed of the unmanned aerial vehicle and the flight path thereof so as to enable the unmanned aerial vehicle to deliver the article in a deliverable time selected by a delivery requester and to cause the monitoring required timing to be included in the time zone in which the monitoring task is performable.

8. The flight control information setting device according to claim 1, wherein the setting code is further configured to cause the at least one processor to perform, in a case where it is difficult to cause the monitoring required timing of the unmanned aerial vehicle to be included in the time zone in which the monitoring task is performable by changing the flight speed of the unmanned aerial vehicle, setting so as to cause the monitoring required timing to be included in the time zone in which the monitoring task is performable by changing the flight path of the unmanned aerial vehicle.

9. The flight control information setting device according to claim 1, wherein
the unmanned aerial vehicle is a first unmanned aerial vehicle,
the monitoring schedule includes a time zone having a monitoring task already allocated thereto and configured to monitor a second unmanned aerial vehicle different from the first unmanned aerial vehicle,
the program code further including change code configured to cause the at least one processor to, in a case where it is difficult to cause the monitoring required timing of the first unmanned aerial vehicle to be included in the time zone in which the operator can perform the monitoring task even if at least one of the flight speed of the first unmanned aerial vehicle and the flight path thereof is changed, change the monitoring required timing of the second unmanned aerial vehicle by changing at least one of the flight speed of the second unmanned aerial vehicle and the flight path thereof, and change, according to a change in the monitoring required timing, the time zone having the monitoring task already allocated thereto and configured to monitor the second unmanned aerial vehicle in the monitoring schedule, and
the setting code is further configured to cause the at least one processor to set at least one of the flight speed of the first unmanned aerial vehicle and the flight path thereof so as to cause the monitoring required timing of the first unmanned aerial vehicle to be included in an idle time zone generated by changing the time zone.

10. The flight control information setting device according to claim 1, the program code further including allocation code configured to cause the at least one processor to allocate, to the time zone, the monitoring task to be performed at the monitoring required timing included in the time zone in which the monitoring task is performable in the monitoring schedule of the operator by setting at least one of the flight speed and the flight path.

11. The flight control information setting device according to claim 1, wherein
the unmanned aerial vehicle includes a first unmanned aerial vehicle and a second unmanned aerial vehicle,
the monitoring schedule of the operator has a monitoring task allocated thereto and configured to monitor the first unmanned aerial vehicle and a monitoring task allocated thereto and configured to monitor the second unmanned aerial vehicle,
the program code further including delay control code configured to cause the at least one processor to delay, in a case where a delay occurs in a delivery schedule of the first unmanned aerial vehicle, the monitoring required timing of the first unmanned aerial vehicle, and
the setting code is further configured to cause the at least one processor to reset, in a case where at least a part of the monitoring required timing after the delay of the first unmanned aerial vehicle and at least a part of the monitoring required timing of the second unmanned aerial vehicle overlap with each other, at least one of the flight speed of the second unmanned aerial vehicle and the flight path thereof so as to cause the monitoring required timing of the second unmanned aerial vehicle to be included in the time zone in which the operator can perform the monitoring task in the monitoring schedule of the operator.

12. The flight control information setting device according to claim 10, wherein
the unmanned aerial vehicle includes a first unmanned aerial vehicle and a second unmanned aerial vehicle,
the monitoring schedule of a first operator among a plurality of the operators has a monitoring task allocated thereto and configured to monitor the first unmanned aerial vehicle and a monitoring task allocated thereto and configured to monitor the second unmanned aerial vehicle,
the program code further including delay control code configured to cause the at least one processor to delay, in a case where a delay occurs in a delivery schedule of the first unmanned aerial vehicle, the monitoring required timing of the first unmanned aerial vehicle, and
the allocation code is further configured to cause the at least one processor to allocate, in a case where at least a part of the monitoring required timing after the delay of the first unmanned aerial vehicle and at least a part of the monitoring required timing of the second unmanned aerial vehicle overlap with each other, the monitoring task to be performed at the monitoring required timing of the second unmanned aerial vehicle to the time zone in which the monitoring task is performable in the monitoring schedule of the first operator or the monitoring schedule of a second operator other than the first operator.

13. The flight control information setting device according to claim 1, the program code further including flight control code configured to cause the at least one processor to control flight of the unmanned aerial vehicle on the basis of at least one of the set flight speed of the unmanned aerial vehicle and the set flight path thereof.

14. The flight control information setting device according to claim 1, the program code further including presentation code configured to cause the at least one processor to present, to a delivery requester of the article, a predetermined number of deliverable time frames of the article by the unmanned aerial vehicle in a selectable manner, wherein
the second acquisition code is further configured to cause the at least one processor to acquire the monitoring required timing on the basis of the deliverable time frame selected by the delivery requester among the presented deliverable time frames.

15. The flight control information setting device according to claim 1, wherein the monitoring schedule has a monitoring task already allocated thereto and configured to monitor another unmanned aerial vehicle deployed in a base different from a base of the unmanned aerial vehicle.

16. The flight control information setting device according to claim 1, the program code further including transmission code configured to cause the at least one processor to transmit, to a terminal used by the operator, information for causing the operator to perform the monitoring task to be performed at the monitoring required timing in response to arrival of the monitoring required timing.

17. The flight control information setting device according to claim 1, wherein the monitoring required timing is at least one of a plurality of timings separated by time in a delivery schedule related to one delivery by the unmanned aerial vehicle.

18. An unmanned aerial vehicle monitoring system comprising:
at least one memory configured to store program code; and at least one processor configured to access the program code and operate as instructed by the program code, the program code including:
first acquisition code configured to cause the at least one processor to acquire a monitoring schedule of an operator who performs a monitoring task for monitoring an unmanned aerial vehicle used for delivering an article, the monitoring schedule including a time zone in which the operator can perform the monitoring task;
second acquisition code configured to cause the at least one processor to acquire a monitoring required timing at which the unmanned aerial vehicle needs to be monitored, the monitoring required timing changing according to a change in at least one of a flight speed of the unmanned aerial vehicle and a flight path thereof; and
setting code configured to cause the at least one processor to set at least one of the flight speed of the unmanned aerial vehicle and the flight path thereof so as to cause the monitoring required timing to be included in the time zone in which the operator can perform the monitoring task in the monitoring schedule of the operator.

19. A flight control information setting method executed by a computer comprising:
acquiring a monitoring schedule of an operator who performs a monitoring task for monitoring an unmanned aerial vehicle used for delivering an article, the monitoring schedule including a time zone in which the operator can perform the monitoring task;
acquiring a monitoring required timing at which the unmanned aerial vehicle needs to be monitored, the monitoring required timing changing according to a change in at least one of a flight speed of the unmanned aerial vehicle and a flight path thereof; and
setting at least one of the flight speed of the unmanned aerial vehicle and the flight path thereof so as to cause the monitoring required timing to be included in the time zone in which the operator can perform the monitoring task in the monitoring schedule of the operator.
